(19) United States
(12) Patent Application Publication
(10) Pub. No.: US 2018/0247088 A1
(43) Pub. Date: Aug. 30, 2018

(54) UNIQUE HARDWARE FINGERPRINT DEVICE AND METHOD

(71) Applicant: Dark Matter L.L.C., Dubai (AE)

(72) Inventors: Jouni Tapio Nevalainen, Li (FI); Mika Petteri Annamaa, Oulunsalo (FI)

(21) Appl. No.: 15/898,031

(22) Filed: Feb. 15, 2018

Related U.S. Application Data
(60) Provisional application No. 62/463,515, filed on Feb. 24, 2017.

(51) Int. Cl. G06F 21/86; G06F 21/88

(52) U.S. Cl. CPC G06F 21/86; G06F 21/88

(57) ABSTRACT

A unique hardware fingerprint device and method are provided. The device comprises a sensor comprising a dense capacitance matrix, the dense capacitance matrix containing a unique hardware fingerprint. The device further comprises a processor configured to secure the device using the unique hardware fingerprint.

### RELATED APPLICATION(S)

This application claims the benefit of U.S. Provisional Patent Application No. 62/463,515 filed Feb. 24, 2017, the entire contents of which are incorporated herein by reference.

### FIELD OF THE INVENTION

The present invention relates to securing computing devices, and more particularly to tamper detection for computing devices.

### BACKGROUND

Techniques for securing computing devices are constantly evolving as people invent new ways of gaining unauthorized access to computing devices. Some techniques involve computer programs installed on the computing devices, or on the network to which the computing devices are connected, in order to secure the data stored therein. These computer programs can be malware detection programs, firewalls, etc.

However, there is also a need to secure computing devices against physical tampering with (i.e. access to) the hardware components of the computing devices. Thus, improved tamper detection techniques are needed to prevent unauthorized access to computing devices.

### SUMMARY

A unique hardware fingerprint device and method are provided. The device comprises a sensor comprising a dense capacitance matrix, the dense capacitance matrix containing a unique hardware fingerprint. The device further comprises a processor configured to secure the device using the unique hardware fingerprint.

### BRIEF DESCRIPTION OF THE DRAWINGS

FIG. 1 illustrates a method for securing a device using a unique hardware fingerprint, in accordance with one embodiment.

FIG. 2 illustrates a method for creating a dense capacitance matrix, in accordance with one embodiment.

FIG. 3 illustrates a process for creating a dense capacitance matrix, in accordance with one embodiment.

FIG. 4 illustrates a dense capacitance matrix, in accordance with one embodiment.

FIG. 5 illustrates a method for securing a device using a unique hardware fingerprint, in accordance with one embodiment.

FIG. 6 illustrates a network architecture, in accordance with one embodiment.

FIG. 7 illustrates an exemplary system, in accordance with one embodiment.

### DETAILED DESCRIPTION

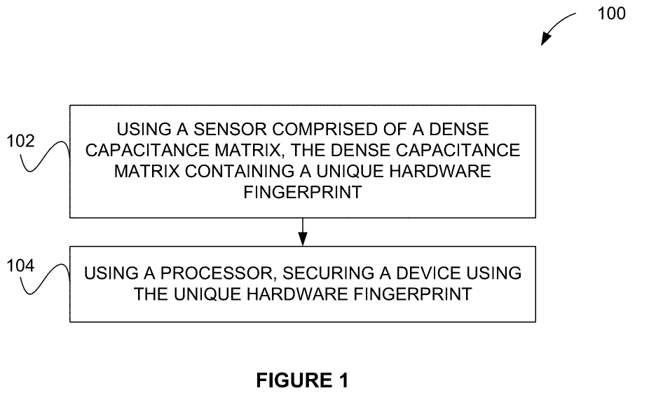

FIG. 1 illustrates a method 100 for securing a device using a unique hardware fingerprint, in accordance with one embodiment. In operation 102, a sensor is used comprised of a dense capacitance matrix, the dense capacitance matrix containing a unique hardware fingerprint. In the context of the present description, the dense capacitance matrix includes a capacitive sensor and a printed electronic material. For example, the capacitive sensor may include a sensor used for capacitive fingerprint sensing. Additionally, the printed electronic material may include a paste-like material such as a carbon conductive material (e.g. DuPont BQ221, DuPont 7105, etc.) which can be printed, dispensed, and deposited. Such printed electronic material may also be stable and durable after curing. In one embodiment, the printed electronic material may be deposited in a random and/or unique manner on the capacitive sensor to create a dense capacitance matrix.

In the context of the present description, the unique hardware fingerprint includes a random composition (e.g. particle size, shape and concentration, etc.) of conductive particles in the printed electronic material, as deposited on the capacitive sensor. Additionally, the unique hardware fingerprint may include a shape and thickness of the deposited printed electronic material on the capacitive sensor. Due to the random composition and shape of the unique hardware fingerprint, only the processor of the dense capacitance matrix may know the unique response of the unique hardware fingerprint. In use, therefore, the processor can be configured to validate the unique hardware fingerprint. Additionally, the unique nature of the unique hardware fingerprint may avoid the unique hardware fingerprint from being cloned.

As indicated in operation 104, using a processor, a device is secured using the unique hardware fingerprint. In the context of the present description, a device is secured when the device is free from or not exposed to a potential risk. A risk may include a loss or damage to the device, to a peripheral associated with the device, to data stored on the device, to software stored on the device, or to any other information associated with the device.

Additionally, a processor may be configured to secure the device using the unique hardware fingerprint. The processor may be further configured to verify the unique hardware fingerprint. A verification of the unique hardware fingerprint may include determining whether a seal of the dense capacitance matrix has been broken. For example, the cured material layer may be capable of being physically broken (i.e. indicating the tampering by change in response to the dense capacitance matrix). In use, therefore, if the dense capacitance matrix seal has been broken, such may be at least one indication that the device has been tampered with in some manner. Of course, it is appreciated that a hard impact (e.g. an extreme mechanical shock, etc.) could potentially break the seal on the unique hardware fingerprint as well. Nonetheless, under most instances, a breaking of the seal on the unique hardware fingerprint may be at least some indication of potential tampering.

The verification of the seal on the unique hardware fingerprint may occur at boot-up of the device, and/or may occur at set intervals (e.g. every ten seconds, etc.). A result of the verification by the processor may indicate whether the seal of the dense capacitance matrix is void or valid.

In a separate embodiment, a method may include combining a capacitive sensor and a printed electronic material to create a dense capacitance matrix. Additionally, the dense capacitance matrix may be used to create a unique hardware fingerprint, wherein the unique hardware fingerprint is used to secure a device.

More illustrative information will now be set forth regarding various optional architectures and uses in which the foregoing method may or may not be implemented, per the desires of the user. It should be noted that the following information is set forth for illustrative purposes and should not be construed as limiting in any manner. Any of the following features may be optionally incorporated with or without the exclusion of other features described.

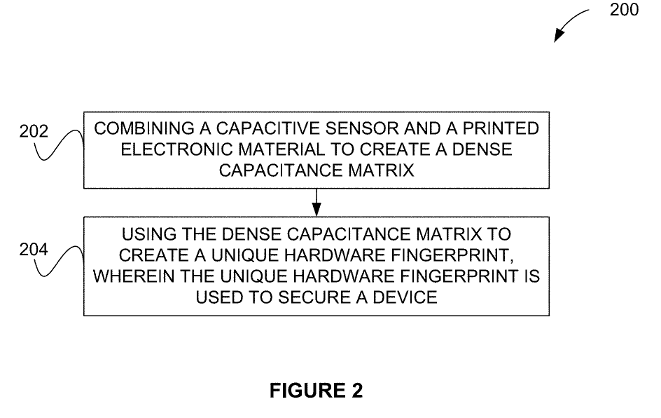

FIG. 2 illustrates a method 200 for creating a dense capacitance matrix, in accordance with one embodiment. As an option, the method 200 may be implemented in the context of any one or more of the embodiments set forth in any previous and/or subsequent figure(s) and/or description thereof. However, it is to be appreciated that the method 200 may be implemented in the context of any desired environment.

As shown in operation 202, a capacitive sensor and a printed electronic material may be combined to create a dense capacitance matrix. As described hereinabove, such printed electronic material may include a paste-like material such as a carbon conductive material (e.g. DuPont BQ221, DuPont 7105, etc.) which can be printed, dispensed, and deposited.

Additionally, in operation 204, the dense capacitance matrix may be used to create a unique hardware fingerprint, where the unique hardware fingerprint is used to secure a device. For example, the unique hardware fingerprint may be analyzed by a processor to determine if a seal of the unique hardware fingerprint has been broken in any way. If the seal is broken, then such may be an indication that the device has been tampered with.

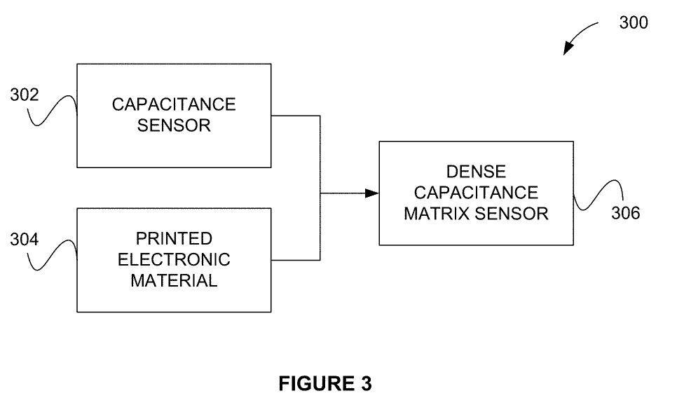

FIG. 3 illustrates a process 300 for creating a dense capacitance matrix, in accordance with one embodiment. As an option, the process 300 may be implemented in the context of any one or more of the embodiments set forth in any previous and/or subsequent figure(s) and/or description thereof. However, it is to be appreciated that process 300 may be implemented in the context of any desired environment. As shown, capacitance sensor 302 is combined with printed electronic material 304 to produce a dense capacitance matrix sensor 306.

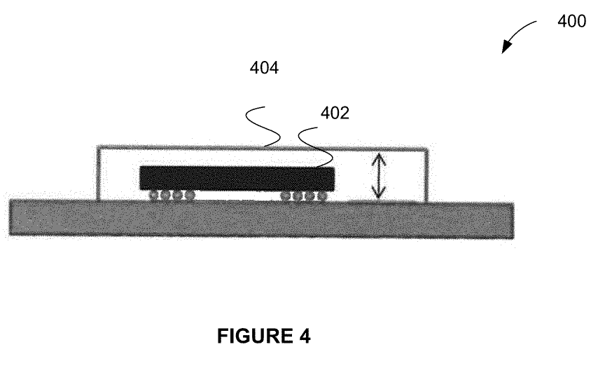

FIG. 4 illustrates a dense capacitance matrix 400, in accordance with one embodiment. As an option, the dense capacitance matrix 400 may be implemented in the context of any one or more of the embodiments set forth in any previous and/or subsequent figure(s) and/or description thereof. For example, the dense capacitance matrix 400 may reflect a result of the process 300 of FIG. 3. However, it is to be appreciated that the dense capacitance matrix 400 may be implemented in the context of any desired environment.

As shown, dense capacitance matrix 400 includes a capacitive sensor 402 surrounded by printed electronic material 404. The double sided arrow shows the amount of printed electronic material 404 surrounding the capacitive sensor 402 (found at the core of the printed electronic material). Of course, it should be noted that while the present embodiment shows the capacitive sensor 402 entirely surrounded by the printed electronic material 404, other embodiments are contemplated where the printed electronic material 404 does not entirely surround the capacitive sensor 402, but instead is combined with (e.g. deposited on) only part of the capacitive sensor 402. For example, the printed electronic material 404 may be deposited on only on a top surface of the capacitive sensor 402, only on a portion of the top surface of the capacitive sensor 402, only on a lateral surface of the capacitive sensor 402, etc.

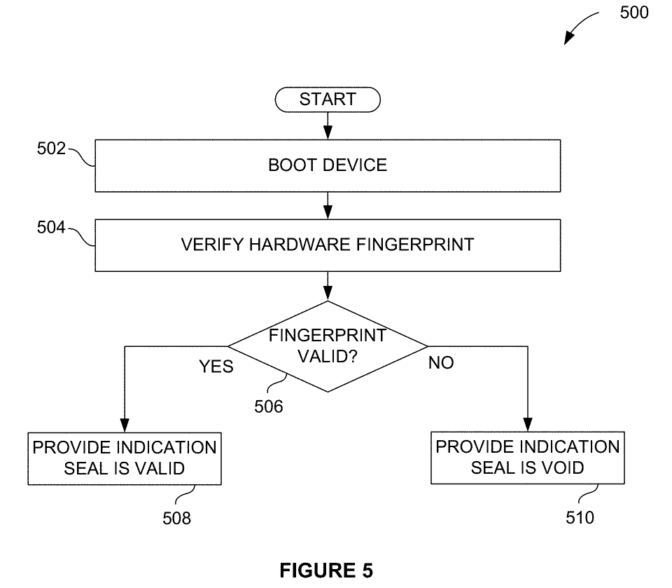

FIG. 5 illustrates a method 500 for securing a device using a unique hardware fingerprint, in accordance with one embodiment. As an option, the method 500 may be implemented in the context of any one or more of the embodiments set forth in any previous and/or subsequent figure(s) and/or description thereof. For example, the method 500 may reflect various steps of operations of the method 100 of FIG. 1. However, it is to be appreciated that the method 500 may be implemented in the context of any desired environment.

As shown, method 500 begins with operation 502 with the device booting. Next, in operation 504, the hardware fingerprint is verified. Decision 506 determines whether the hardware fingerprint is valid. If the fingerprint is determined to be valid, then per operation 508, an indication is provided that the seal is valid, whereas if the fingerprint is not determined to be valid, then per operation 510, an indication is provided that the seal is void.

In an alternative embodiment and as described hereinabove, although method 500 focuses on conducting the verification step during the boot sequence of the device (e.g. operation 502, etc.), the verification process (e.g. operation 504, decision 506, operations 508-510, etc.) may be conducted at set time intervals (e.g. every ten seconds, any arbitrary time amount, etc.) after the device is booted.

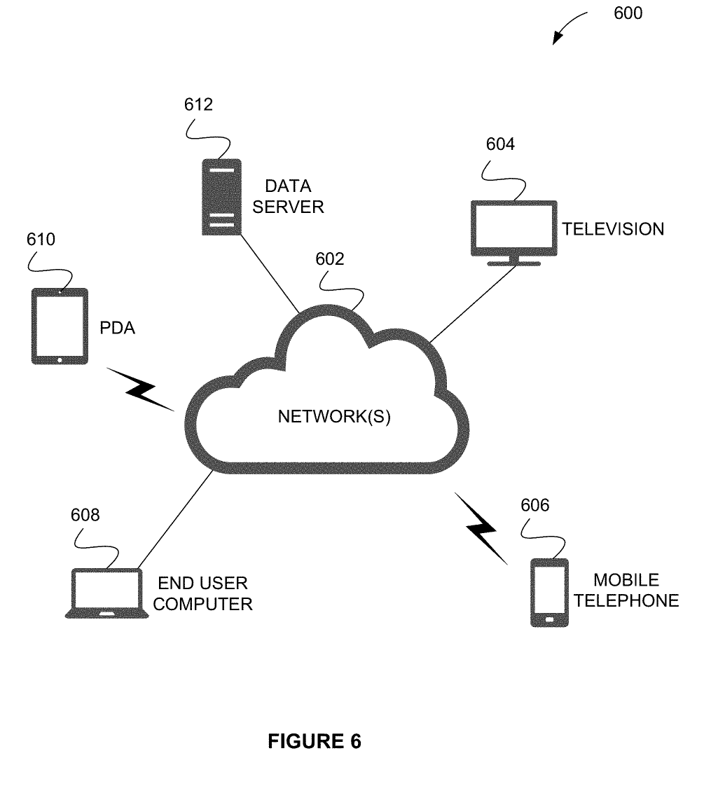

FIG. 6 illustrates a network architecture 600, in accordance with one embodiment. As shown, at least one network 602 is provided. In the context of the present network architecture 600, the network 602 may take any form including, but not limited to a telecommunications network, a local area network (LAN), a wireless network, a wide area network (WAN) such as the Internet, peer-to-peer network, cable network, etc. While only one network is shown, it should be understood that two or more similar or different networks 602 may be provided.

Coupled to the network 602 is a plurality of devices. For example, a server computer 612 and an end user computer 608 may be coupled to the network 602 for communication purposes. Such end user computer 608 may include a desktop computer, lap-top computer, and/or any other type of logic. Still yet, various other devices may be coupled to the network 602 including a personal digital assistant (PDA) device 610, a mobile phone device 606, a television 604, etc.

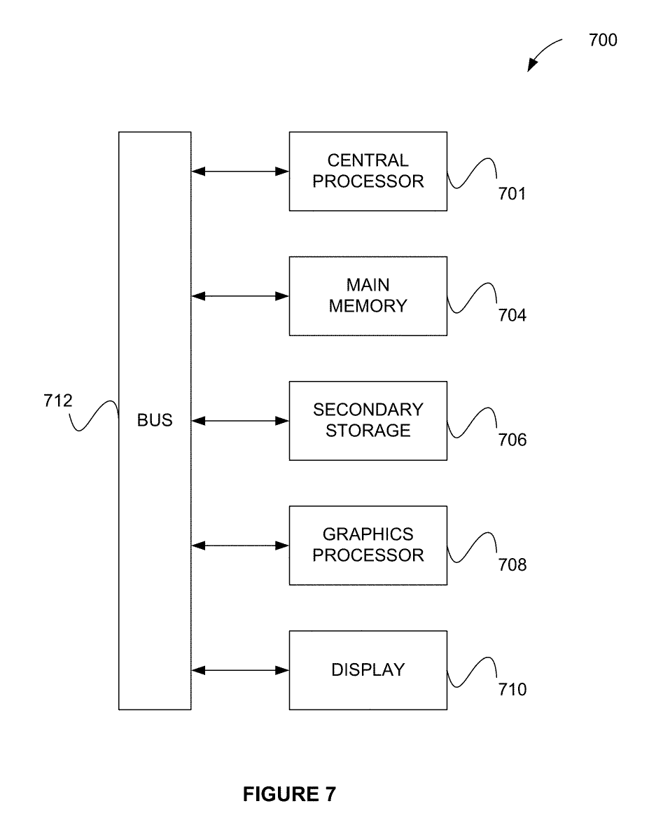

FIG. 7 illustrates an exemplary system 700, in accordance with one embodiment. As an option, the system 700 may be implemented in the context of any of the devices of the network architecture 600 of FIG. 6. However, it is to be appreciated that the system 700 may be implemented in any desired environment.

As shown, a system 700 is provided including at least one central processor 702 which is connected to a bus 712. The system 700 also includes main memory 704 [e.g., hard disk drive, solid state drive, random access memory (RAM), etc.]. The system 700 also includes a graphics processor 708 and a display 710.

The system 700 may also include a secondary storage 706. The secondary storage 706 includes, for example, a hard disk drive and/or a removable storage drive, representing a floppy disk drive, a magnetic tape drive, a compact disk drive, etc. The removable storage drive reads from and/or writes to a removable storage unit in a well-known manner.

Computer programs, or computer control logic algorithms, may be stored in the main memory 704, the secondary storage 706, and/or any other memory, for that matter. Such computer programs, when executed, enable the system 700 to perform various functions (as set forth above, for example). Memory 704, secondary storage 706 and/or any other storage are possible examples of non-transitory computer-readable media.

In one embodiment, means, in accordance with the structures described above, are provided to: use a sensor comprised of a dense capacitance matrix, the dense capacitance matrix containing a unique hardware fingerprint; and secure a device using the unique hardware fingerprint, using a processor. In another embodiment, means, in accordance with the structures described above, are provided to: combine a capacitive sensor and a printed electronic material to create a dense capacitance matrix; and use the dense capacitance matrix to create a unique hardware fingerprint, wherein the unique hardware fingerprint is used to secure a device.

Optionally, in any of the preceding embodiments, the processor is further configured to verify the unique hardware fingerprint. As a further option, the verification includes determining whether a seal of the dense capacitance matrix has been broken. As another option, the verification occurs at boot-up of the device. As another option, the verification occurs at set intervals. As yet another option, the set interval is every ten seconds. As still yet another option, the verification produces a result indicating either a seal of the dense capacitance matrix is void or valid.

Optionally, in any of the preceding embodiments, the dense capacitance matrix is comprised of a capacitive sensor and a printed electronic material.

Optionally, in any of the preceding embodiments, the unique hardware fingerprint cannot be cloned.

It is noted that the techniques described herein, in an aspect, are embodied in executable instructions stored in a computer readable medium for use by or in connection with an instruction execution machine, apparatus, or device, such as a computer-based or processor-containing machine, apparatus, or device. It will be appreciated by those skilled in the art that for some embodiments, other types of computer readable media are included which may store data that is accessible by a computer, such as magnetic cassettes, flash memory cards, digital video disks, Bernoulli cartridges, random access memory (RAM), read-only memory (ROM), and the like.

As used here, a “computer-readable medium” includes one or more of any suitable media for storing the executable instructions of a computer program such that the instruction execution machine, system, apparatus, or device may read (or fetch) the instructions from the computer readable medium and execute the instructions for carrying out the described methods. Suitable storage formats include one or more of an electronic, magnetic, optical, and electromagnetic format. A non-exhaustive list of conventional exemplary computer readable medium includes: a portable computer diskette; a RAM; a ROM; an erasable programmable read only memory (EPROM or flash memory); optical storage devices, including a portable compact disc (CD), a portable digital video disc (DVD), a high definition DVD (HD-DVD™), a BLU-RAY disc; and the like.

It should be understood that the arrangement of components illustrated in the Figures described are exemplary and that other arrangements are possible. It should also be understood that the various system components (and means) defined by the claims, described below, and illustrated in the various block diagrams represent logical components in some systems configured according to the subject matter disclosed herein.

For example, one or more of these system components (and means) may be realized, in whole or in part, by at least some of the components illustrated in the arrangements illustrated in the described Figures. In addition, while at least one of these components are implemented at least partially as an electronic hardware component, and therefore constitutes a machine, the other components may be implemented in software that when included in an execution environment constitutes a machine, hardware, or a combination of software and hardware.

More particularly, at least one component defined by the claims is implemented at least partially as an electronic hardware component, such as an instruction execution machine (e.g., a processor-based or processor-containing machine) and/or as specialized circuits or circuitry (e.g., discreet logic gates interconnected to perform a specialized function). Other components may be implemented in software, hardware, or a combination of software and hardware. Moreover, some or all of these other components may be combined, some may be omitted altogether, and additional components may be added while still achieving the functionality described herein. Thus, the subject matter described herein may be embodied in many different variations, and all such variations are contemplated to be within the scope of what is claimed.

In the description above, the subject matter is described with reference to acts and symbolic representations of operations that are performed by one or more devices, unless indicated otherwise. As such, it will be understood that such acts and operations, which are at times referred to as being computer-executed, include the manipulation by the processor of data in a structured form. This manipulation transforms the data or maintains it at locations in the memory system of the computer, which reconfigures or otherwise alters the operation of the device in a manner well understood by those skilled in the art. The data is maintained at physical locations of the memory as data structures that have particular properties defined by the format of the data. However, while the subject matter is being described in the foregoing context, it is not meant to be limiting as those of skill in the art will appreciate that various of the acts and operations described hereinafter may also be implemented in hardware.

To facilitate an understanding of the subject matter described herein, many aspects are described in terms of sequences of actions. At least one of these aspects defined by the claims is performed by an electronic hardware component. For example, it will be recognized that the various actions may be performed by specialized circuits or circuitry, by program instructions being executed by one or more processors, or by a combination of both. The description herein of any sequence of actions is not intended to imply that the specific order described for performing that sequence must be followed. All methods described herein may be performed in any suitable order unless otherwise indicated herein or otherwise clearly contradicted by context.

The use of the terms “a” and “an” and “the” and similar referents in the context of describing the subject matter (particularly in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. Furthermore, the foregoing description is for the purpose of illustration only, and not for the purpose of limitation, as the scope of protection sought is defined by the claims as set forth hereinafter together with any equivalents thereof entitled to. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

The embodiments described herein include the one or more modes known to the inventor for carrying out the claimed subject matter. It is to be appreciated that variations of those embodiments will become apparent to those of ordinary skill in the art upon reading the foregoing description. The inventor expects skilled artisans to employ such variations as appropriate, and the inventor intends for the claimed subject matter to be practiced otherwise than as specifically described herein. Accordingly, this claimed subject matter includes all modifications and equivalents of the subject matter recited in the claims appended hereto as permitted by applicable law. Moreover, any combination of the above-described elements in all possible variations thereof is encompassed unless otherwise indicated herein or otherwise clearly contradicted by context.

What is claimed is:

1. A device, comprising:
a sensor comprising a dense capacitance matrix, the dense capacitance matrix containing a unique hardware fingerprint; and
a processor configured to secure the device using the unique hardware fingerprint.

2. The device of claim 1, wherein the processor is further configured to verify the unique hardware fingerprint.

3. The device of claim 2, wherein the verification includes determining whether a seal of the dense capacitance matrix has been broken.

4. The device of claim 2, wherein the verification occurs at boot-up of the device.

5. The device of claim 2, wherein the verification occurs at set intervals.

6. The device of claim 5, wherein the set interval is every ten seconds.

7. The device of claim 1, wherein the dense capacitance matrix is comprised of a capacitive sensor and a printed electronic material.

8. The device of claim 1, wherein the unique hardware fingerprint cannot be cloned.

9. The device of claim 2, wherein the verification produces a result indicating either a seal of the dense capacitance matrix is void or valid.

10. A method, comprising:
using a sensor comprised of a dense capacitance matrix, the dense capacitance matrix containing a unique hardware fingerprint; and
using a processor, securing a device using the unique hardware fingerprint.

11. The method of claim 10, wherein the processor is further configured to verify the unique hardware fingerprint.

12. The method of claim 11, wherein the verification includes determining whether a seal of the dense capacitance matrix has been broken.

13. The method of claim 11, wherein the verification occurs at boot-up of the device.

14. The method of claim 11, wherein the verification occurs at set intervals.

15. The method of claim 14, wherein the set interval is every ten seconds.

16. The method of claim 10, wherein the dense capacitance matrix is comprised of a capacitive sensor and a printed electronic material.

17. The method of claim 10, wherein the unique hardware fingerprint cannot be cloned.

18. The method of claim 11, wherein the verification produces a result indicating either a seal of the dense capacitance matrix is void or valid.

19. A method, comprising:
combining a capacitive sensor and a printed electronic material to create a dense capacitance matrix;
using the dense capacitance matrix to create a unique hardware fingerprint, wherein the unique hardware fingerprint is used to secure a device.
